(19) United States
(12) Patent Application Publication
(10) Pub. No.: US 2021/0065134 A1
(43) Pub. Date: Mar. 4, 2021

(54) INTELLIGENT NOTIFICATION SYSTEM

(71) Applicant: Microsoft Technology Licensing, LLC, Redmond, WA (US)

(72) Inventors: Shalendra Chhabra, Seattle, WA (US); Jason Thomas Faulkner, Seattle, WA (US); Eric Sexauer, Woodville, WA (US)

(21) Appl. No.: 16/557,659

(22) Filed: Aug. 30, 2019

(51) Int. Cl. G06Q 10/10; H04L 29/08; G06F 3/0482; G06F 3/0484; G06F 9/451

(52) U.S. Cl. CPC G06Q 10/1095; H04L 67/306; G06F 9/453; G06F 3/0482; G06F 3/04847; H04L 67/26

(57) ABSTRACT

Techniques for providing intelligent notifications including detecting an event associated with a user. User data is analyzed to determine whether a notification is to be generated for the event. The user data relates to the activities, preferences, and learned behaviors of a user with respect to one or more applications and/or past notifications. When a notification is to be generated, an emphasis level can be determined for the notification. The notification can include one or more selectable options that enable a user to respond to the notification and/or perform an action in response to the notification.

### BACKGROUND

Individuals and organizations must typically keep track of various documents, tasks, meetings, and other events. Additionally, in some situations, an individual wants or needs to review content related to the events the user is directly involved with and/or content associated with related events that the individual is not involved with directly. In many organizations, each individual is responsible for finding and gathering the material he or she wants to review, which can be a time consuming process. It can also be a challenging or frustrating process when the individual cannot locate the content, or is not aware of the event or the content associated with the event.

It is with respect to these and other general considerations that embodiments have been described. Also, although relatively specific problems have been discussed, it should be understood that the embodiments should not be limited to solving the specific problems identified in the background.

### SUMMARY

Embodiments disclosed herein provide techniques for providing intelligent notifications for an event to a user. In one aspect, a method includes a computer-implemented method of operating a notification assistant includes detecting an event and analyzing user data to determine whether to provide a notification for the event. The user data can include data associated with the learned behaviors of a user with respect to interactions with past notifications and optionally with one or more applications. Based on a determination to provide the notification for the event, the notification assistant automatically surfaces a user interface that includes a selectable option to respond to the notification and a selectable control element associated with the selectable option. The selectable option is associated with the calendar application. The user interface is transmitted to a computing device, and a selection of the selectable control element is received from the computing device. Based on the selection, the notification assistant performs the action in the calendar application that is associated with the selectable option.

In another aspect, a system includes a processing device and a memory operably connected to the processing device. The memory stores instructions, that when executed by the processing device, cause the system to detect an event and analyze user data to determine whether to provide a notification for the event. In some embodiments, the user data includes data associated with the learned behaviors of a user with respect to interactions with past notifications and with one or more applications. Based on a determination to provide the notification for the event, a user interface is automatically surfaced, where the user interface includes a selectable option to respond to the notification and a selectable control element associated with the selectable option. The selectable option is associated with the calendar application. The user interface is transmitted to a computing device, and a selection of the selectable control element is received from the computing device. Based on the selection, an action associated with the selectable option is performed in the calendar application.

In yet another aspect, a computer-implemented method includes detecting an event. Based on a determination to provide a notification for the event, user data is analyzed to determine an emphasis level for the notification. An emphasis level is a prominence or a stress given to the notification and/or the content in the notification. A notification with the determined emphasis level is automatically generated, where the notification includes a user interface with a plurality of selectable options to respond to the notification and a selectable control element associated with each selectable option. The notification is sent to a computing device, and a selection of a particular selectable control element is received. Based on the received selection, the selectable option associated with the selected selectable control element is performed.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 depicts an example intelligent notification system;

FIGS. 2A-2B illustrate a flowchart of an example method of providing a notification to a user;

FIG. 3 depicts a flowchart of an example method of detecting an event associated with an application in the group of applications;

FIG. 4 illustrates a flowchart of an example method of adjusting an emphasis level for a notification;

FIG. 5 depicts a flowchart of an example method of a user providing one or more settings for notifications;

FIG. 6 illustrates an example notification;

FIG. 7A depicts a first example graphical user interface for setting a timeline for notifications;

FIG. 7B illustrates a second example graphical user interface for setting a timeline for notifications;

FIG. 8 depicts an example application that can be used to provide content to a user;

FIG. 9 is a block diagram depicting example physical components of a computing device with which aspects of the disclosure may be practiced;

FIGS. 10A-10B are simplified block diagrams illustrating a mobile computing device with which aspects of the present disclosure may be practiced; and

FIG. 11 is a block diagram depicting a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Disclosed herein are embodiments for providing intelligent notifications. A notification can be generated in response to the detection of an event. The events are associated with the user either directly or indirectly. For example, the event can be a task assigned to the user that has an upcoming deadline, or the user missed the deadline. The event may be a meeting the user was invited to and missed. Additionally or alternatively, the event may be the uploading of a document that is related to a project the user is working on, or the user had drafted or edited in the past. An event can also be a discussion in an electronic message or group chat that is associated with a subject of interest to the user. A notification assistant predicts whether an event is of interest and/or is relevant to the user, and if so, generates a notification for the event.

Based on the detection of the event, user data is analyzed to determine whether a notification is to be generated for the event. The user data relates to the activities, preferences, and learned behaviors of a user with respect to the group of applications and past notifications. When a notification is to be generated, an emphasis level can be determined for the notification. An emphasis level is a prominence or a stress given to the notification and/or the content in the notification. For example, with a first emphasis level, the font size and/or color of the text in the notification is a default size and/or color, such as a 12-point black font. In a second emphasis level that is higher than the first emphasis level, the font size and/or color of the text in the notification is larger and/or brighter, such as a 14-point font and/or red font.

Additionally or alternatively, how the notification is presented on a computing device can be based on an emphasis level. At one emphasis level, the presentation of the notification to a user is less conspicuous. For example, the notification can be displayed as a reminder in a calendar program or as a notification in a notification panel. At a higher emphasis level, the notification may be sent in an electronic communication or displayed in a graphical user interface (GUI) in a more conspicuous manner, such as in a pop-up panel that is displayed as the active panel (e.g., positioned on top of the previously active panel).

In some embodiments, which computing device the notification is sent to is based on an emphasis level. For example, with a first emphasis level, the notification is sent to one computing device associated with the user, such as the user's laptop. In a second emphasis level that is higher than the first emphasis level, the notification is sent to the user's cell phone or tablet. Additionally or alternatively, the notification can be sent to one or more computing devices based on the notification level. At one emphasis level, the notification is sent to a first computing device and at a higher second level the notification is sent to the first computing device and to a second computing device, or to two different computing devices (not including the first computing device).

The notification can include one or more selectable options that enable a user to respond to the notification and/or perform an action in response to the notification. A selectable control element is associated with each selectable option and is used to select a particular selectable option. The notification assistant can automatically perform an action in response to the receipt of a selection of a selectable control option. The action includes, but is not limited to, scheduling time on the user's calendar, opening (or causing to open) the user's calendar, and opening (or causing to open) another application, such as a reminder application.

In some embodiments, the event is associated with an application that is included in a group of applications. For example, the applications in the group of applications can be a part of a suite of applications. In general, a suite of applications is a collection of software applications that provide related (and possibly integrated) functionality. In some instances, the collection of software applications share a similar user interface and the ability to exchange data with each other. In such embodiments, the user data that is analyzed to determine whether to provide the notification is user data that is associated with the applications in the group of applications.

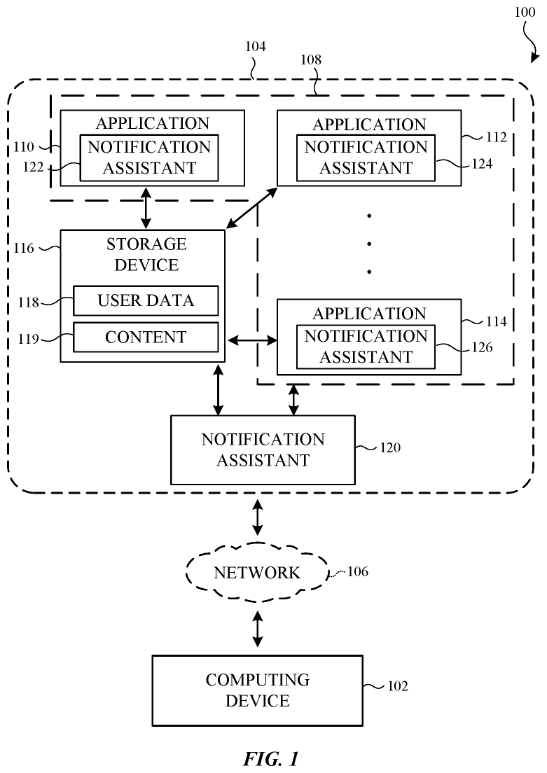

Non-limiting and non-exhaustive examples are described with reference to the following FIGS. 1-11. The elements of the drawings are not necessarily to scale relative to each other. Identical reference numerals have been used, where possible, to designate identical features that are common to the figures.

FIG. 1 depicts an example intelligent notification system. The system 100 includes one or more computing devices (represented by computing device 102) and an intelligent notification environment 104. In one embodiment, the intelligent notification environment 104 is implemented in the computing device 102. In another embodiment, the computing device 102 accesses the intelligent notification environment 104 over a network 106. For example, the intelligent notification environment 104 can be implemented on one or more additional computing devices (e.g., one or more servers) that the computing device 102 accesses through a distributed computing network (e.g., the Internet) and/or an intranet.

The intelligent notification environment 104 includes a group of applications 108, where the group includes N applications and N is a number greater than one. In the illustrated embodiment, the group of applications 108 includes a first application 110, a second application 112, and a third application 114. In other embodiments, the group of applications 108 can include two or more applications.

The applications 110, 112, 114 can be any type of application including, but not limited to, an electronic communications application, a group chat application, an online meeting application, a word processing or spreadsheet application, a reminder application, a document management application, and an application that combines two or more applications into a shared workspace application or a family of applications. An example of a shared workspace application is MICROSOFT TEAMS and an example of a family of applications is MICROSOFT OFFICE.

The applications 110, 112, 114 in the group of applications 108 are predetermined in one embodiment. For example, the applications 110, 112, 114 can be a part of a suite of applications. In general, a suite of applications is a collection of software applications that provide related (and possibly integrated) functionality. In some instances, the collection of software applications share a similar user interface and the ability to exchange data with each other. One example of a suite of applications is MICROSOFT OFFICE.

In another embodiment, the applications 110, 112, 114 in the group of applications 108 are selected by a system administrator and/or the user of the computing device 102. In a non-limiting example, the user can select the applications that form the group of applications through a user interface or settings menu.

The intelligent notification environment 104 further includes one or more storage devices (represented by storage device 116) in which the applications 110, 112, 114 store user data 118. In one embodiment, the user data 118 is obtained based on a user interacting with the applications 110, 112, 114 in the group of applications 108 and is shared by the applications 110, 112, 114. Other embodiments can obtain the user data based on other user interactions or activities.

In general, the user data 118 relates to the activities, preferences, and learned behaviors of a user. As will be described in more detail later, the user data 118 is obtained based at least on the user's responses and interactions with the notifications that are provided by the notification assistant 120. Any suitable storage device 116 can be used. For example, the storage device 116 includes, but is not limited to, volatile storage (e.g., random access memory), non-volatile storage (e.g., read-only memory), flash memory, or any combination of such memories.

The storage device 116 further stores content 119 associated with the applications 110, 112, 114. The content 119 includes content that is associated with the events in which notifications are provided by the notification assistant 120. The content 119 can be any suitable content including, but not limited to, documents, video recordings, audio recordings, a transcript, a task or list of tasks, and the like.

The notification assistant 120 accesses the user data 118 and, based on the user data 118, generates notifications and provides the notifications to the computing device 102. As will be described in more detail later, the notification assistant 120 learns over time which notifications a user interacts with and/or prefers to improve the content of the notifications, the presentation of the notifications, and/or the events in which notifications are generated for the user.

The notification assistant 120 also monitors and/or interacts with the applications 110, 112, 114 to detect events that cause the notification assistant 120 to generate and provide the notifications to the computing device 102. The events are associated with the user either directly or indirectly. For example, the event can be a task assigned to the user that has an upcoming deadline, or the user missed the deadline. The event may be a meeting the user was invited to and missed. Additionally or alternatively, the event may be the uploading of a document that is related to a project the user is working on, or the user had drafted or edited in the past. An event can also be a discussion in an electronic message or group chat that is associated with a subject of interest to the user. The notification assistant 120 predicts whether an event is of interest and/or is relevant to the user, and if so, generates a notification for the event.

In some embodiments, each application 110, 112, 114 includes a notification assistant 122, 124, 126, respectively, that either replaces the notification assistant 120 or works in combination with the notification assistant 120 to detect events, generate notifications, and/or interact with the application associated with the notification assistant 122, 124, 126. In one example embodiment, the notification assistant 120 and/or the notification assistants 122, 124, 126 include artificial intelligence or one or more machine learning (ML) algorithms to learn the user's behaviors and preferences to predict the events for notifications, the content of the notifications, and/or the presentation of the notifications.

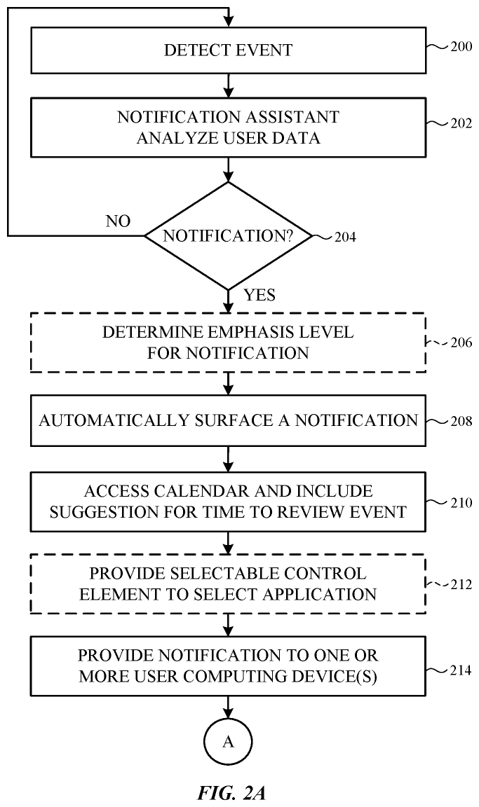

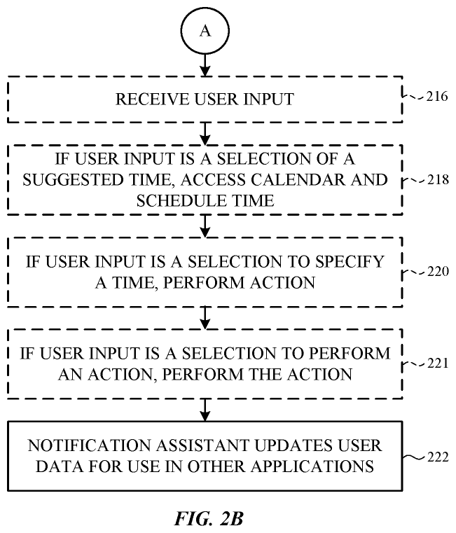

FIGS. 2A-2B illustrate a flowchart of an example method of providing a notification to a user. Initially, as shown in block 200, the notification assistant detects an event that is associated with a user. As described earlier, the event can be directly or indirectly related to the user and an application.

The notification assistant accesses the user data stored in the storage device (e.g., user data 118 in FIG. 1) to determine whether a notification should be generated for the event (block 202). A determination is then made at block 204 as to whether a notification is to be generated or not. If not, the process returns to block 200 and waits until another event is detected.

When it is determined a notification is to be generated, the method continues at optional block 206 where an emphasis level for the notification is determined. An emphasis level is a prominence or a stress given to the notification and/or the content in the notification. For example, with a first emphasis level, the font size and/or color of the text in the notification is a default size and/or color, such as a 12-point black font. In a second emphasis level that is higher than the first emphasis level, the font size and/or color of the text in the notification is larger and/or brighter, such as a 14-point font and/or red font.

Additionally or alternatively, how the notification is presented on a computing device is based on an emphasis level. At one emphasis level, the presentation of the notification to a user is less conspicuous. For example, the notification can be displayed as a reminder in a calendar program or as a notification in a notification panel. At a higher emphasis level, the notification may be sent in an electronic communication or displayed in a graphical user interface (GUI) in a more conspicuous manner, such as in a pop-up panel that is displayed as the active panel (e.g., positioned on top of the previously active panel).

In some embodiments, which computing devices the notification is sent to is based on an emphasis level. For example, with a first emphasis level, the notification is sent to one computing device associated with the user, such as the user's laptop. In a second emphasis level that is higher than the first emphasis level, the notification is sent to the user's cell phone or tablet. Additionally or alternatively, the notification can be sent to one or more computing devices based on the notification level. At one emphasis level, the notification is sent to a first computing device and at a higher second level the notification is sent to the first computing device and to a second computing device, or to two different computing devices (not including the first computing device). Block 206 is optional and can be omitted in other embodiments.

The notification is automatically surfaced or generated at block 208. In one embodiment, the automatic surfacing of the notification occurs without user input or interaction. In some implementations, the notification includes a statement asking if the user wants to specify a time to review the event and/or content associated with the event (e.g., content 119 in FIG. 1). In another embodiment, the notification includes one or more suggested times for the user to review the event and/or the content associated with the event. To determine the suggested time(s), the notification assistant accesses the user's calendar and determines one or more times in which the user is available (block 210). The notification assistant can analyze the user data to ascertain the user's preferences for the times to review the event and/or content. The notification assistant includes at least one of the one or more times in the notification.

When the notification includes the statement asking if the user wants to specify a time to review the event and/or content associated with the event, or the notification includes one or more suggested times for the user to review the event and/or the content, the notification assistant automatically surfaces a selection control element for the statement or a selection control element for each suggested time to enable the user to respond to the statement or to select a particular suggested time (block 212). The notification is then sent to one or more computing devices (block 214).

A selection of a selection control element can be received as a user input at optional block 216. The user input can be a response to the statement asking if the user wants to specify a time to review the event and/or content associated with the event, or a response to the one or more suggested times to review the event and/or the content. When the user input is a selection of a particular suggested time, the notification assistant accesses the user's calendar and creates an appointment on the calendar for the user (block 218). When the user wants to specific a time to review the event and/or the content, the notification assistant can perform one or more actions responsive to the user's selection (block 220). For example, the notification assistant may suggest one or more times to the user, may open the user's calendar to enable the user to create an appointment on the calendar to review the event and/or content, can present a second notification that enables the user to specify a time and, based on the specified time, and/or the notification assistant creates an appointment on the user's calendar.

Additionally or alternatively, the notification assistant may access another application in response to the user's selection. In non-limiting embodiments, the notification assistant can enter a reminder to review the event and/or the content into a reminder application and/or send the user an electronic communication with the content attached to the electronic communication at a future time.

In some instances, the notification assistant can recommend an action for the user. For example, the recommended action can relate to a next step that the notification assistant predicts the user is to perform. Example recommended actions include, but are not limited to, scheduling a meeting, sending a document, and/or sending an electronic communication. As such, as shown in block 221, the notification assistant performs the action when the user input is a selection to perform an action.

The notification assistant updates the user data based on the user's response, the user's interaction with the notification, and/or the response(s) of the notification assistant (block 222). Updating the user data enables the notification assistant to learn over time to generate notifications that are tailored to the user's preferences, which in turn improve the effectiveness of the notifications. Blocks 212, 216, 218, 220 are optional and can be omitted in other embodiments.

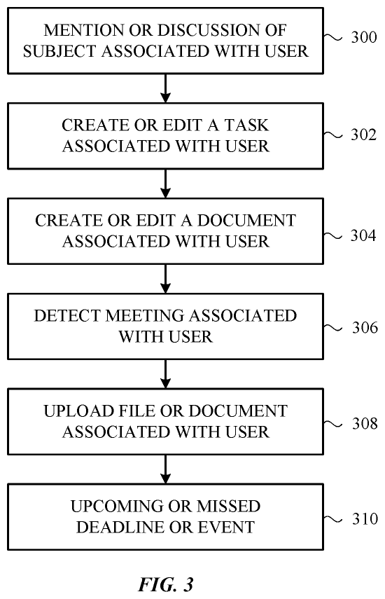

FIG. 3 depicts a flowchart of an example method of detecting an event associated with an application in the group of applications (e.g., applications 110, 112, 114 in group of applications 108 in FIG. 1). The illustrated process is performed in block 200 in FIG. 2. At least one block of blocks 300, 302, 304, 306, 308, 310 is executed when the process shown in FIG. 3 is performed. For example, block 302 can be performed while blocks 300, 304, 306, 308, 310 are not performed. Other embodiments can include additional or different events than the events shown in FIG. 3.

As described earlier, each application in the group of applications can be any type of application including, but not limited to, an electronic communications application, a group chat application, an online meeting application, a word processing or spreadsheet application, a reminder application, a document management application, a shared workspace application, or a family of applications. A notification can be generated for any event that is directly or indirectly associated with an application and with a user. In one aspect, the notification assistant learns the events to provide notifications for based on the user's historical and current interactions with notifications that are provided by the notification assistant.

Initially, as shown in block 300, a notification assistant can detect a discussion or mention of a subject that is associated with a user. The “subject” is anything of interest to the user. In non-limiting examples, a “subject” is a person, a document, a file, a task, a meeting, an organization, a project, or a department. The discussion or reference to the subject can occur in an electronic communication, a group chat, a document, an online meeting, a task, and other activities associated with the applications in the group of applications.

Next, as shown in block 302, a task that is associated with the user that is created or edited may be detected. For example, the task can be created during an online meeting or in a reminder application. Additionally or alternatively, a document that is created or edited and is associated with the user can be detected at block 304. The document is any suitable type of document, and the application in the group of applications is an application that corresponds to the document type. For example, the document is a word processing document, a presentation document, a web page, a video, or a spreadsheet document. Correspondingly, the application is a word processing application, a presentation application, a web browser, a video player, or a spreadsheet application.

At block 306, a meeting that is associated with the user is detected. The user may be invited to the meeting and/or the meeting can relate to a subject that is of interest to the user. For example, the user may be a designer on a project while the meeting relates to the marketing activities for the project. Although the user is not working directly on the marketing activities, the project may be of interest of the user. Thus, in some embodiments, the intelligent assistant will provide a notification to the user for the meeting. The notification assistant can detect the meeting based on an analysis of the user's calendar, the user's electronic communications, tasks, or other activities associated with the group of applications.

Uploading a document or file that is associated with the user can be detected at block 308. Example documents and files include, but are not limited to, a video, a word processing document, a presentation document, a web page, and a spreadsheet document, an audio recording, and the like.

An upcoming or missed deadline or event is detected at block 310. The deadline or event is associated with an application in the group of applications. For example, the user may have missed a deadline for a task, there can be an upcoming deadline for a document, or the user may have missed a meeting that is on the user's calendar.

As described earlier, at least one block in FIG. 3 is executed when the process is performed. Other embodiments can include additional or different events than the events shown in FIG. 3.

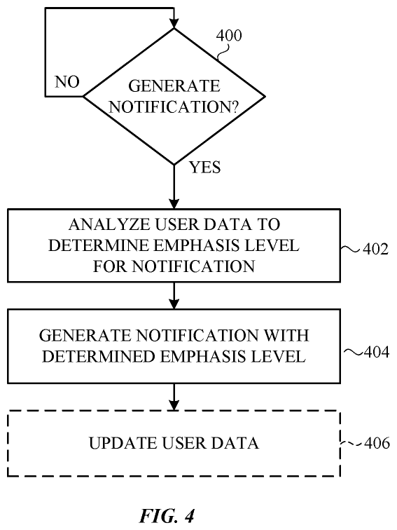

FIG. 4 illustrates a flowchart of an example method of adjusting an emphasis level for a notification. The process shown in FIG. 4 can be performed at block 206 in FIG. 2. Initially, a determination is made at block 400 as to whether or not a notification is to be generated. If not, the process waits until a notification is to be generated. When a notification will be generated, the process continues at block 402 where a notification assistant accesses the user data to determine an emphasis level for the notification. The emphasis level is based at least on user interactions with past notifications and/or user feedback on prior notifications. For example, the emphasis level can be higher when a user has responded to one or more past notifications on a subject. Since the user data is updated with the past notification(s) and the past user response(s) (e.g., block 218 in FIG. 2 and block 406), the notification assistant can analyze that user data to determine whether the user prefers the notification include a particular emphasis or not.

Next, as shown in block 404, the notification is generated with the determined emphasis level. As described earlier, the emphasis level can determine the font size of the text in the notification (e.g., at a certain, minimum, or maximum font size). The color of the text can be selected based on the emphasis level. Additionally or alternatively, how conspicuously the notification is presented on a computing device is based on an emphasis level. In some embodiments, which computing devices the notification is sent to is based on an emphasis level. Other features or characteristics of a notification and/or the content of a notification can be determined by the emphasis level.

The user data can then be updated with the determined emphasis level at optional block 406. In one embodiment, the user data is updated when the determined emphasis level changes to a different emphasis level (e.g., higher). Alternatively, the user data is not updated when the determined emphasis level remains the same. In some embodiments, the user data is updated regardless of whether the determined emphasis level changes or remains the same. In this manner, the analysis of the emphasis level can be stored and quickly reconsidered (and possibly revised) each time the emphasis level is reviewed.

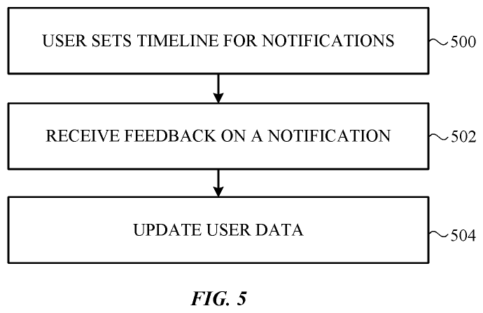

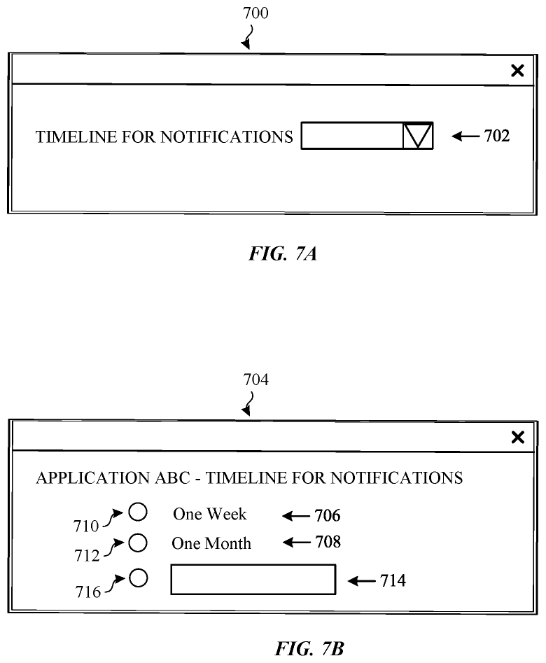

FIG. 5 depicts a flowchart of an example method of a user providing one or more settings for notifications. At least one block of blocks 500 and 502 is executed when the process shown is performed. Initially, as shown in block 500, a user can set a timeline for the notification assistant. The timeline defines a time period in which notifications will be generated by the notification assistant. For example, a user can receive notifications for events detected in one or more applications over the past week, the past month, or the past six weeks. Example techniques for setting a timeline are described in more detail in conjunction with FIGS. 7A-7B.

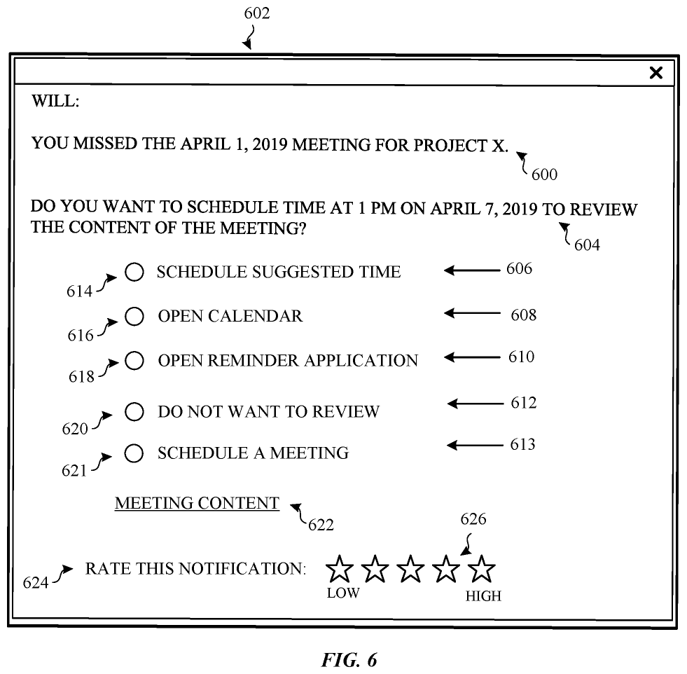

Next, as shown in block 502, feedback on a notification is received from the user at block 502. The feedback can be provided with or after each notification or at select times. In some embodiments, the user data (e.g., user data 118 in FIG. 1) is updated with the feedback to enable the notification assistant to learn the user's activities, preferences, and behaviors over time. An example technique for a user to provide feedback is described in more detail in conjunction with FIG. 6. The user data is updated with the feedback and/or the timeline at block 506.

FIG. 6 illustrates an example notification. The message 600 in the notification 602 provides a description of the event associated with the notification 602. In the illustrated embodiment, the notification 602 informs “Will” that he missed a meeting on Apr. 1, 2019. The message also includes a statement 604 asking Will if he wants to schedule a time to review the content associated with the meeting and provides a suggested time for the review.

The notification 602 includes one or more selectable options to enable Will to respond to the statement 604. In the illustrated embodiment, the notification 602 includes five selectable options 606, 608, 610, 612, 613. The selectable option 606 will cause the notification assistant to schedule time at 1 pm on Apr. 7, 2019 on Will's calendar to review the content. Will can select the selectable option 606 by selecting the selectable control element 614.

The selectable option 608 will cause the notification assistant to open Will's calendar, or cause the notification assistant to provide a menu option that will open Will's calendar. This enables Will to review his calendar and manually select a time to review the content associated with the meeting on Apr. 1, 2019. Will can select the selectable option 608 by selecting the selectable control element 616.

The selectable option 610 will cause the notification assistant to open another application, or cause the notification assistant to provide a menu option to open the application. When the selectable control element 618 is selected, Will is able to respond to the statement 604 with a different application. In the illustrated embodiment, the application listed in the selectable option 610 is a reminder application. Thus, when the selectable control element 618 is selected, Will can create a reminder in the reminder application to review the content associated with the meeting on Apr. 7, 2019.

The selectable option 612 enables Will to indicate he does not want to review the content. When the selectable control element 620 is selected, the notification assistant receives input that informs the notification assistant that no further action is to be taken. In some embodiments, the notification assistant learns over time that Will does not want to receive notifications for the event and stops providing the notifications. Alternatively, the notification assistant learns over time that Will does not want to receive notifications for the event but continues to provide the notifications. In some embodiments, the notifications are provided at a given emphasis level (e.g., a minimum or default emphasis level).

As described previously, the notification assistant can recommend an action for the user. For example, the recommended action can relate to a next step that the notification assistant predicts the user is to perform. In the illustrated embodiment, the selectable option 613 presents the recommended action of scheduling a meeting. When the selectable control element 621 is selected, the notification assistant receives input to schedule a meeting. The notification assistant can open a calendar application to allow Will to manually select a day and time for the meeting. Alternatively, the notification assistant can analyze the user data and generate a meeting invitation that includes recommended invitees as well as a day and time. In some instances, the notification assistant may present several recommended meeting times in a second user interface.

In some embodiments, the notification assistant can automatically include the content to be reviewed with the notification 602. In a non-limiting example, the content may be one or more attachments to the notification when the notification 602 is provided in an electronic communication. Alternatively, the notification assistant can include a link to the content in the notification 602. In the illustrated embodiment, a link 622 is provided in the notification 602 to enable Will to access the content.

As described previously, a user can provide feedback on a notification. The user may rank the overall effectiveness of the notification, or the user can provide feedback on specific features in the notification. In FIG. 6, the notification 602 includes a feedback statement 624 that enables Will to rank the overall effectiveness of the notification 602. The feedback is provided by selecting one or more selectable feedback controls 626 (e.g., the stars). In other embodiments, different types of selectable feedback controls 626 may be used. Additionally, feedback can be given using dialog boxes that enable Will to suggest other content or features he would like included in a future notification.

FIG. 7A depicts a first example graphical user interface for setting a timeline for notifications. The timeline sets a time period in which the notification assistant will review and provide notifications for events that occur within that time period. For example, a user can receive notifications for events detected in one or more applications over the past week, the past two weeks, or the past month. In this manner, a user can specify that notifications be presented for more recent events compared to events that happened some time ago, where the content associated with an event that happened too late in the past may no longer be current or relevant.

The user interface 700 includes a selectable control element 702 (e.g., a drop down menu) that includes pre-determined selectable options that a user selects. For example, the drop down menu can include selectable options such as a week, two weeks, and a month.

FIG. 7B illustrates a second example graphical user interface for setting a timeline for notifications. The user interface 704 depicts two selectable options 706, 708 of one week and one month, respectively. A user can select one of the two selectable options 706, 708 via a respective selectable control element 710, 712. The illustrated user interface 704 further includes a dialog box 714 that enables the user to enter a particular time period when the selectable control element 716 associated with the dialog box 714 is selected. Typically, the particular time period is a time period that is not shown in the selectable options 706,708. For example, the user can enter a two weeks into the dialog box 714.

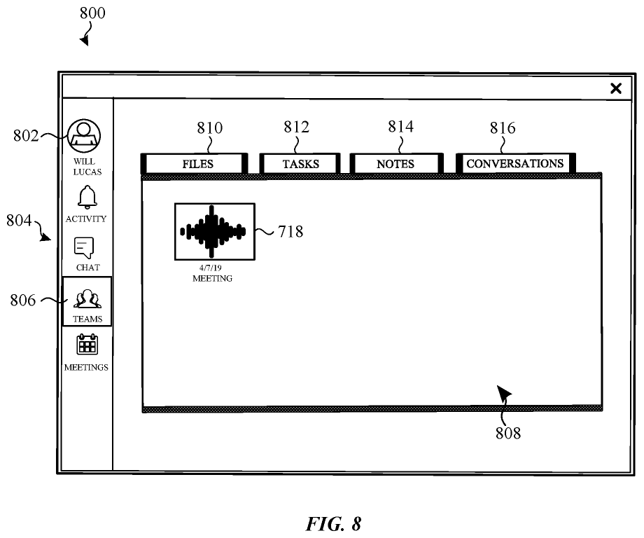

FIG. 8 illustrates an example application that can be used to provide content to a user. The application can be a meeting application, a shared workspace application, or any other suitable application. For example, a link in a notification can enable a user to open the application and access the content (e.g., link 622 in FIG. 6). Alternatively, a user may manually open the application to access the content.

In the illustrated embodiment, the user interface 800 of the application is associated with the user Will Lucas, as indicated by the graphic or image 802. The user interface 800 includes a menu 804 of different operations of the application. In FIG. 8, the “Teams” icon 806 is selected. The Teams user interface 808 includes a Files tab 810, a Tasks tab 812, a Notes tab 814, and a Conversations tab 816. Other embodiments can include different and/or additional tabs.

The tabs 810, 812, 814, 816 are areas where content associated with an event can be stored and accessed by a user (e.g., Will). For example, a video recording 818 of the Apr. 1, 2019 meeting is stored under the Files tab 810. Additionally or alternatively, documents can be stored under the Files tab 810. Example types of documents include, but are not limited to, word processing documents, presentation documents, and spreadsheet documents. The tasks associated with Will Lucas can be stored under the Tasks tab 812. The tasks can be tasks will is responsible for directly or tasks that relate to a subject associated with Will Lucas. Additionally or alternatively, one or more comments or conversation threads may be stored under the Conversations tab 816.

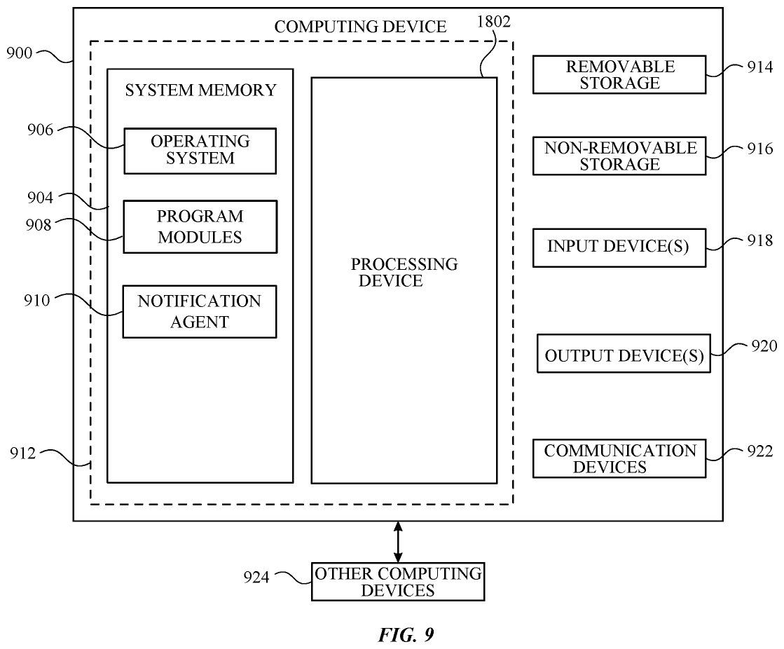

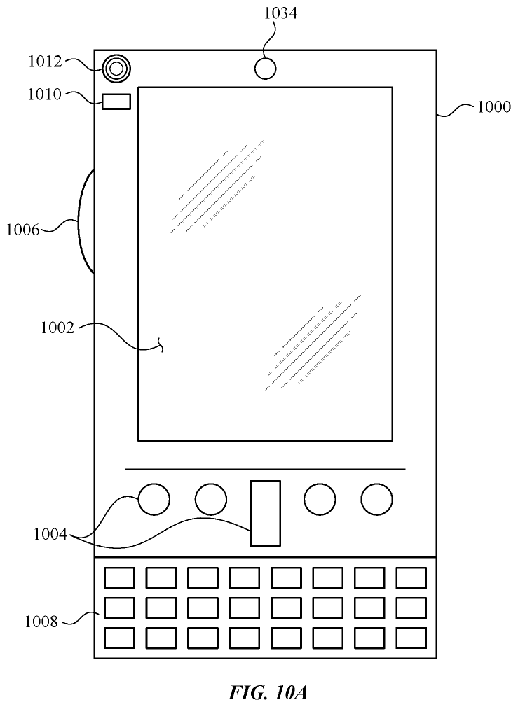

FIGS. 9-11 and the associated descriptions provide a discussion of a variety of operating environments in which aspects of the disclosure may be practiced. However, the devices and systems illustrated and discussed with respect to FIGS. 9-11 are for purposes of example and illustration and are not limiting of a vast number of electronic device configurations that may be utilized for practicing aspects of the disclosure, as described herein.

FIG. 9 is a block diagram illustrating physical components (e.g., hardware) of an electronic device 900 with which aspects of the disclosure may be practiced. In a basic configuration, the electronic device 900 may include at least one processing device 902 and a memory 904. Any suitable processing device 902 can be used. For example, the processing device 902 may be a microprocessor, an application specific integrated circuit, a field programmable gate array, or combinations thereof.

Depending on the configuration and type of the electronic device 900, the memory 904 may comprise, but is not limited to, volatile storage (e.g., random access memory), non-volatile storage (e.g., read-only memory), flash memory, or any combination of such memories. The memory 904 may include a number of program modules and data files, such as an operating system 906, program modules 908, and a notification assistant 910. While executing on the processing device 902, the notification assistant 910 may perform and/or cause to be performed processes including, but not limited to, the aspects as described herein.

In some embodiments, the notification assistant 910 can be any suitable type of machine learning or artificial intelligence that learns over time and improves the notification process. For example, the notification assistant 910, executing on the processing device 902, can learn which events to provide notifications to a user, which content to include in the notifications, and the like. Using the learned aspects of the notification process, over time the notification assistant 910 becomes more efficient and effective in providing notifications to the user.

The operating system 906, for example, may be suitable for controlling the operation of the electronic device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 912.

The electronic device 900 may have additional features or functionality. For example, the electronic device 900 may also include additional data storage devices (removable and/or non-removable) such as, for example, magnetic disks, optical disks, or tape. Such additional storage is illustrated in FIG. 9 by a removable storage device 914 and a non-removable storage device 916.

The electronic device 900 may also have one or more input device(s) 918 such as a keyboard, a trackpad, a mouse, a pen, a sound or voice input device, a touch, force and/or swipe input device, etc. The output device(s) 920 such as a display, speakers, a printer, etc. may also be included. The aforementioned devices are examples and others may be used. The electronic device 900 may include one or more communication devices 922 allowing communications with other electronic devices 924. Examples of suitable communication devices 922 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The memory 904, the removable storage device 914, and the non-removable storage device 916 are all computer storage media examples (e.g., memory storage or storage device). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 900. Any such computer storage media may be part of the electronic device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

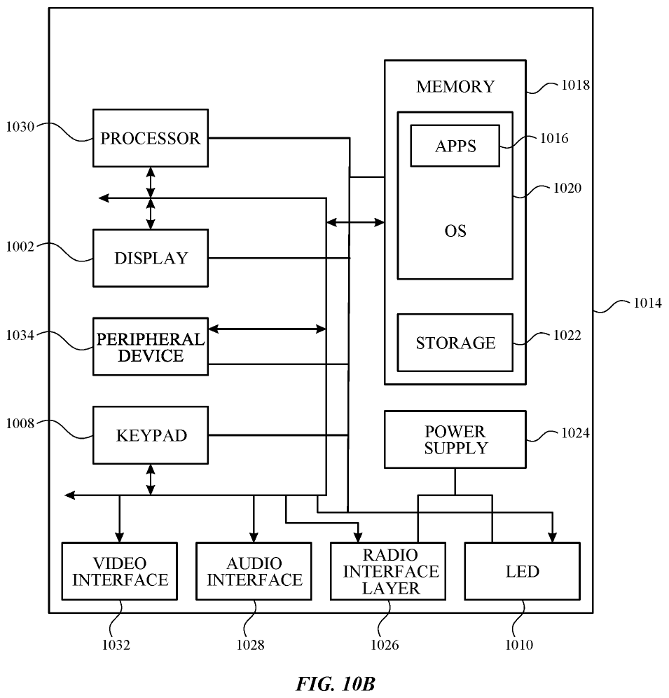

FIGS. 10A and 10B illustrate a mobile electronic device 1000, for example, a mobile telephone, a smart phone, wearable computer (such as a smart watch), a tablet computer, a laptop computer, and the like, with which embodiments of the disclosure may be practiced. With reference to FIG. 10A, one aspect of a mobile electronic device 1000 for implementing the aspects described herein is illustrated.

In a basic configuration, the mobile electronic device 1000 is a handheld computer having both input elements and output elements. The mobile electronic device 1000 typically includes a display 1002 and one or more input buttons 1004 that allow the user to enter information into the mobile electronic device 1000. The display 1002 of the mobile electronic device 1000 may also function as an input device (e.g., a display that accepts touch and/or force input).

If included, an optional side input element 1006 allows further user input. The side input element 1006 may be a rotary switch, a button, or any other type of manual input element. In alternative aspects, mobile electronic device 1000 may incorporate more or less input elements. For example, the display 1002 may not be a touch screen in some embodiments. In yet another alternative embodiment, the mobile electronic device 1000 is a portable phone system, such as a cellular phone. The mobile electronic device 1000 may also include an optional keypad 1008. Optional keypad 1008 may be a physical keypad or a “soft” keypad generated on the touch screen display.

In various embodiments, the output elements include the display 1002 for showing a graphical user interface (GUI) of an calendaring or PIP program, a visual indicator 1010 (e.g., a light emitting diode), and/or an audio transducer 1012 (e.g., a speaker). In some aspects, the mobile electronic device 1000 incorporates a vibration transducer for providing the user with tactile feedback. In yet another aspect, the mobile electronic device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile electronic device 1000. That is, the mobile electronic device 1000 can incorporate a system (e.g., an architecture) 1014 to implement some aspects. In one embodiment, the system 1014 is implemented as a “smart phone” capable of running one or more applications (e.g., browser, e-mail, calendaring, contact managers, messaging clients, games, media clients/players, diagramming, and sharing applications and so on). In some aspects, the system 1014 is integrated as an electronic device, such as an integrated personal digital assistant (PDA) and wireless phone.

One or more application programs 1016 may be loaded into the memory 1018 and run on or in association with the operating system 1020. Examples of the application programs include a phone dialer program, an electronic communication program (e.g., electronic mail program, instant message program), a notification assistant program, a word processing program, a spreadsheet program, an Internet browser program, and so forth.

The system 1014 also includes a non-volatile storage area 1022 within the memory 1018. The non-volatile storage area 1022 may be used to store persistent information that should not be lost when the system 1014 is powered down.

The application programs 1016 may use and store information in the non-volatile storage area 1022, such as email, attachments or other messages used by an email application, and the like. A synchronization application (not shown) also resides on the system 1014 and is programmed to interact with a corresponding synchronization application resident on a host computer to keep the information stored in the non-volatile storage area 1022 synchronized with corresponding information stored at the host computer.

The system 1014 has a power supply 1024, which may be implemented as one or more batteries. The power supply 1024 may further include an external power source, such as an AC adapter or a powered docking cradle that supplements or recharges the batteries.

The system 1014 may also include a radio interface layer 1026 that performs the function of transmitting and receiving radio frequency communications. The radio interface layer 1026 facilitates wireless connectivity between the system 1014 and the “outside world,” via a communications carrier or service provider. Transmissions to and from the radio interface layer 1026 are conducted under control of the operating system 1020. In other words, communications received by the radio interface layer 1026 may be disseminated to the application programs 1016 via the operating system 1020, and vice versa.

The visual indicator 1010 may be used to provide visual notifications, and/or an audio interface 1028 may be used for producing audible notifications via an audio transducer (e.g., audio transducer 1012 illustrated in FIG. 10A). In the illustrated embodiment, the visual indicator 1010 is a light emitting diode (LED) and the audio transducer 1012 may be a speaker. These devices may be directly coupled to the power supply 1024 so that when activated, they remain on for a duration dictated by the notification mechanism even though the processor 1030 and other components might shut down for conserving battery power. The LED may be programmed to remain on indefinitely until the user takes action to indicate the powered-on status of the device.

The audio interface 1028 is used to provide audible signals to and receive audible signals from the user (e.g., voice input such as described above). For example, in addition to being coupled to the audio transducer 1012, the audio interface 1028 may also be coupled to a microphone to receive audible input, such as to facilitate a telephone conversation. In accordance with embodiments of the present disclosure, the microphone may also serve as an audio sensor to facilitate control of notifications, as will be described below.

The system 1014 may further include a video interface 1032 that enables an operation of peripheral device 1034 (e.g., on-board camera) to record still images, video stream, and the like.

A mobile electronic device 1000 implementing the system 1014 may have additional features or functionality. For example, the mobile electronic device 1000 may also include additional data storage devices (removable and/or non-removable) such as, magnetic disks, optical disks, or tape. Such additional storage is illustrated in FIG. 10B by the non-volatile storage area 1022.

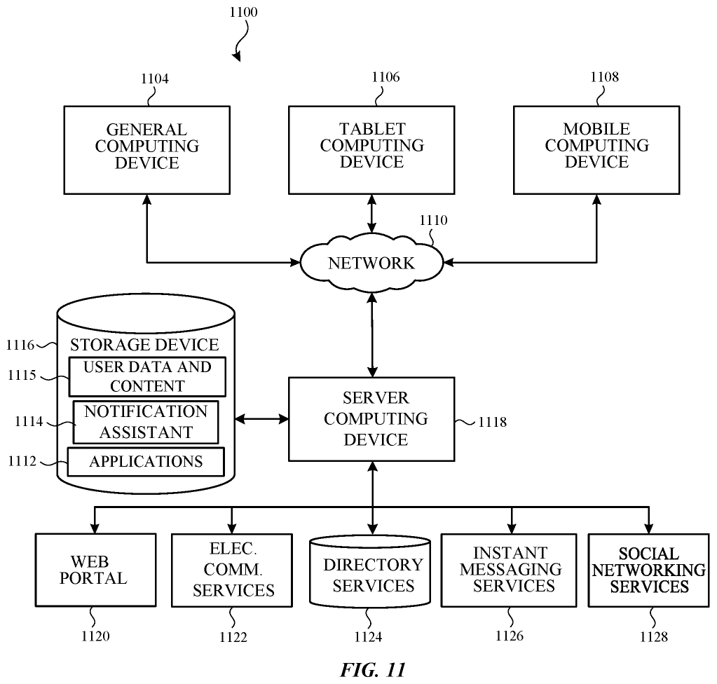

Data/information generated or captured by the mobile electronic device 1000 and stored via the system 1014 may be stored locally on the mobile electronic device 1000, as described above, or the data may be stored on any number of storage media that may be accessed by the device via the radio interface layer 1026 or via a wired connection between the mobile electronic device 1000 and a separate electronic device associated with the mobile electronic device 1000, for example, a server-computing device in a distributed computing network, such as the Internet (e.g., server computing device 1118 in FIG. 11). As should be appreciated such data/information may be accessed via the mobile electronic device 1000 via the radio interface layer 1026 or via a distributed computing network. Similarly, such data/information may be readily transferred between electronic devices for storage and use according to well-known data/information transfer and storage means, including electronic mail and collaborative data/information sharing systems.

As should be appreciated, FIG. 10A and FIG. 10B are described for purposes of illustrating the present methods and systems and is not intended to limit the disclosure to a particular sequence of steps or a particular combination of hardware or software components.

FIG. 11 is a block diagram illustrating a distributed system in which aspects of the disclosure may be practiced. The system includes a general computing device 1104 (e.g., a desktop computer), a tablet computing device 1106, and/or a mobile computing device 1108. The general computing device 1104, the tablet computing device 1106, and the mobile computing device 1108 can each include the components, or be connected to the components, that are shown associated with the electronic device 900 in FIG. 9 or the mobile electronic device 1000 in FIGS. 10A-10B.

The general computing device 1104, the tablet computing device 1106, and the mobile computing device 1108 are each configured to access one or more networks (represented by network 1110) to interact with the applications 1112 in a group of applications stored in one or more storage devices (represented by storage device 1116) and executed on one or more server computing devices (represented by server computing device 1118). The storage device 1116 further stores a notification assistant 1114 and the user data shared by the group of applications and/or content 1115 associated with the applications 1112.

In some aspects, the server computing device 1118 can access and/or receive various types of services, communications, documents and information transmitted from other sources, such as a web portal 1120, an electronic communications services 1122, directory services 1124, instant messaging and/or text services 1126, and/or social networking services 1128. In some instances, these sources may provide robust reporting, analytics, data compilation and/or storage service, etc., whereas other services may provide search engines or other access to data and information, images, graphics, videos, document processing and the like.

As should be appreciated, FIG. 11 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternative aspects falling within the spirit of the broader aspects of the general inventive concept embodied in this application that do not depart from the broader scope of the claimed disclosure.

1. A computer-implemented method of operating a notification assistant, the method comprising:
analyzing data included in communications associated a user;
based on a result of the analyzing, detecting an event that identifies the user;
in response to detecting the event:
accessing calendar data of the user;
identifying a suggested time slot based on available time in the calendar data of the user;
causing a notification of the identified event to display via a graphical user interface at a computing device of the user;
causing the graphical user interface to display the calendar data of the user, the displayed calendar data including the suggested time slot for a new event formed from the identified event;
receiving a user input via the graphical user interface confirming the suggested time slot for the new event; and
updating the calendar data of the user based on the user input by adding the new event to the suggested time slot.

2. The computer-implemented method of claim 1, further comprising:
generating the graphical user interface comprising a control element that identifies a calendar application, wherein the user input indicates a selection of the control element; and
causing a display of an operation of the calendar application in response to the selection of the control element.

3. The computer-implemented method of claim 1, further comprising:
generating the graphical user interface comprising a control element that identifies the available time,
wherein the user input indicates a selection of the available time with the control element,
wherein updating the calendar data is based on the selection of the available time.

4. The computer-implemented method of claim 1, wherein updating the calendar data of the user comprises adding a new event at the available time to the calendar data, the new event identifying a task associated with the event.

5. The computer-implemented method of claim 1, further comprising:
analyzing the data to determine whether to provide a notification for the event, the data comprising user data associated with learned behaviors of the user with respect to interactions with past notifications and with one or more applications;
based on a determination to provide the notification for the event, causing a display of the graphical user interface that comprises the notification, a selectable option to respond to the notification, and a selectable control element associated with the selectable option, wherein the selectable option is associated with a calendar application;
receiving, from the user input, a selection of the selectable control element; and
based on the selection, performing an action in the calendar application that is associated with the selectable option,
wherein the graphical user interface comprises a link to content associated with the event.

6. The computer-implemented method of claim 5, wherein:
the user interface comprises a first user interface; and
the method further comprises causing display of a second user interface at the computing device that enables the user to set a timeline for the notification assistant, the timeline defining a time period in which the notification assistant will review and provide notifications for events that occur within that time period.

7. The computer-implemented method of claim 5, wherein
the event is associated with an application in a group of applications;
the user data is shared by the group of applications;
the user data comprises data associated with the learned behaviors of the user with respect to the interactions with past notifications and with the group of applications; and
the method further comprises updating the user data shared by the group of applications based on the selection of the selectable control element and the action performed in the calendar application.

8. The computer-implemented method of claim 1, wherein the event comprises one of:
uploading a document associated with the user;
creating or editing a task associated with the user; or
creating or editing a document associated with the user.

9. The computer-implemented method of claim 1, wherein the event comprises one of:
a meeting associated with the user; or
an upcoming deadline associated with the user.

10. A system, comprising:
a processing device; and
a memory operably connected to the processing device and storing instructions, that when executed by the processing device, cause the system to perform operations comprising:
analyzing data included in communications associated a user;
based on a result of the analyzing, detecting an event that identifies the user;
in response to detecting the event:
accessing calendar data of the user;
identifying a suggested time slot based on available time in the calendar data of the user;
causing a notification of the identified event to display via a graphical user interface at a computing device of the user;
causing the graphical user interface to display the calendar data of the user, the displayed calendar data including the suggested time slot for a new event formed from the identified event;
receiving a user input via the graphical user interface confirming the suggested time slot for the new event; and
updating the calendar data of the user based on the user input by adding the new event to the suggested time slot.

11. The system of claim 10, wherein the operations further comprise:
generating the graphical user interface comprising a control element that identifies a calendar application, wherein the user input indicates a selection of the control element; and
causing a display of an operation of the calendar application in response to the selection of the control element.

12. The system of claim 11, wherein the operations further comprise:
generating the graphical user interface comprising a control element that identities the available time,
wherein the user input indicates a selection of the available time with the control element,
wherein updating the calendar data is based on the selection of the available time.

13. The system of claim 11, wherein updating the calendar data of the user comprises adding a new event at the available time to the calendar data, the new event identifying a task associated with the event.

14. The system of claim 11, wherein:
the user interface comprises a first user interface; and
the memory stores further instructions to cause a display of a second user interface at the computing device that enables the user to set a timeline for the notification assistant, the timeline defining a time period in which the notification assistant will review and provide notifications for events that occur within that time period.

15. The system of claim 11, wherein causing display of the user interface that includes the selectable option and the selectable control element associated with the selectable option further comprises causing display of a feedback statement to enable the user to provide feedback to on the notification.

16. The system of claim 11, wherein the event comprises one of:
uploading a document associated with the user;
creating or editing a task associated with the user;
creating or editing a document associated with the user;
a meeting associated with the user;
an upcoming deadline associated with the user; or
the user missing the event.

17-20. (canceled)
